(19) United States
(12) Patent Application Publication
(10) Pub. No.: US 2003/0233762 A1
(43) Pub. Date: Dec. 25, 2003

(54) Tape measure housing with grip element

(76) Inventors: William C. Blackman, Raleigh, NC (US); James M. Critelli, Fuquay-Varina, NC (US)

Correspondence Address: COATS & BENNETT, PLLC, P O BOX 5, RALEIGH, NC, 27602, US

(21) Appl. No.: 10/174,629

(22) Filed: Jun. 19, 2002

(51) Int. Cl. G01B 3/10

(52) U.S. Cl. 33/769

(57) ABSTRACT

A tape measure housing, and a tape measure incorporating the housing, includes a main case and an elastomeric grip element mated to the main case. The main case has first and second sidewalls and a peripheral wall extending between the sidewalls which help jointly define an internal chamber therewithin for housing the coilable tape blade. An elastomeric grip element having a perimeter edge is disposed over at least a portion of the top portion, at least a portion of the rear end portion of the case, and at least a portion of the first and second sidewalls. The outer surface of the first and second sidewalls is external recess-free proximate the perimeter edge of the grip element.

### FIELD OF THE INVENTION

The present invention is directed generally to tape measures and, more particularly, to a tape measure and/or housing therefor with an associated elastomeric grip.

### BACKGROUND OF THE INVENTION

Modern tape measures (or “tape rules”) typically include a coiled tape that is spring-biased towards a retracted position. A housing generally surrounds protects the tape and biasing spring and includes an opening through which a distal end of the tape extends. The distal end of the tape is pulled away from the housing during use, and when released, the spring pulls the tape back into the housing so that the tape returns to the retracted position.

One important consideration when designing commercially available tape measures is user comfort, or “feel,” during use and transport. This “feel” is a function of the shape of the tape measure housing, its weight, the quality of construction, and the materials used. A number of different materials and numerous tape measure housing configurations have been used over time in order to achieve a comfortable feel during use. Some older tape measure designs, such as that shown in U.S. Pat. No. 4,527,334 to Jones et al., rely on a resilient rubber or soft polyvinylchloride grip strip to aid in gripping. This grip strip includes a plurality of lateral ridges and overlays a substantial portion of the peripheral wall of the tape measure housing, but does not cover portions of the corresponding sidewalls. As the Jones grip strip does not extend over any portion of the sidewalls, at least a portion of the user's hand directly contacts the hard outer shell of the housing where the shell meets the grip strip. The feel of this intersection may be uncomfortable to many users, particularly as the Jones grip strip resides in a recess that runs along the peripheral wall, thereby creating the opportunity for “pinching” of the user's hand.

Another design disclosed in U.S. Pat. No. 5,746,004 to Wertheim uses an elastomeric grip element that fits within a recess on the peripheral wall, where the recess and the grip element both extend around to the sidewalls of the housing. Because the grip element fits within the recess, and is bounded by the step-like profile of the recess lip, the user's hand may still be “pinched” by tape measures of this design.

Accordingly, there remains a need for improved tape measure housing designs, particularly those that may include a harder shell with an associated softer grip element for better feel.

### SUMMARY OF THE INVENTION

The present invention is directed to a tape measure housing, and a tape measure incorporating the housing, that includes a main case and an elastomeric grip element mated to the main case. The main case has first and second sidewalls and a peripheral wall extending between the sidewalls. The peripheral wall typically has a bottom portion, an top portion, a front end portion, and a rear end portion. The sidewalls and the peripheral wall help jointly define an internal chamber therewithin for housing the coilable tape blade. The peripheral wall has an opening communicating with the chamber for passage of a tape blade therethrough disposed proximate the junction between the front end portion and the bottom portion. An elastomeric grip element having a perimeter edge is disposed over at least a portion of the both the top portion and the rear end portion of the case, and covers at least a portion of the first and second sidewalls. Preferably, the grip element extends a limited distance across the sidewalls to cover a perimeter section thereof while leaving a central portion uncovered. In this fashion, the grip element has an open, generally C-shaped cross-section rather than an O-shaped cross-section. The grip element does not fit within a recess that spills over onto the sidewalls as in Wertheim; instead, the first and second sidewalls are external recess-free proximate the perimeter edge of the elastomeric grip element (but may have internal recesses).

The elastomeric grip element may taper inward proximate the perimeter edge and may optionally extend around to overlay at least a portion of the bottom portion. The shell may optionally comprise a pair of mating shell portions and the grip element may optionally comprises a pair of cooperating sections comolded to the corresponding shell portions of the housing.

### BRIEF DESCRIPTION OF THE DRAWINGS

FIG. 1 is a side view of one tape measure embodiment constructed in accordance with the present invention.

FIG. 2 is a perspective view of one portion of one embodiment of a tape measure housing in accordance with the present invention.

FIG. 3 is a partially exploded view of the components of FIG. 2.

FIG. 4 is a partial vertical cross-sectional view of the tape measure housing embodiment of FIG. 2.

FIG. 5 corresponds to FIG. 4 and shows the concept of a footprint for the shell.

### DETAILED DESCRIPTION OF THE INVENTION

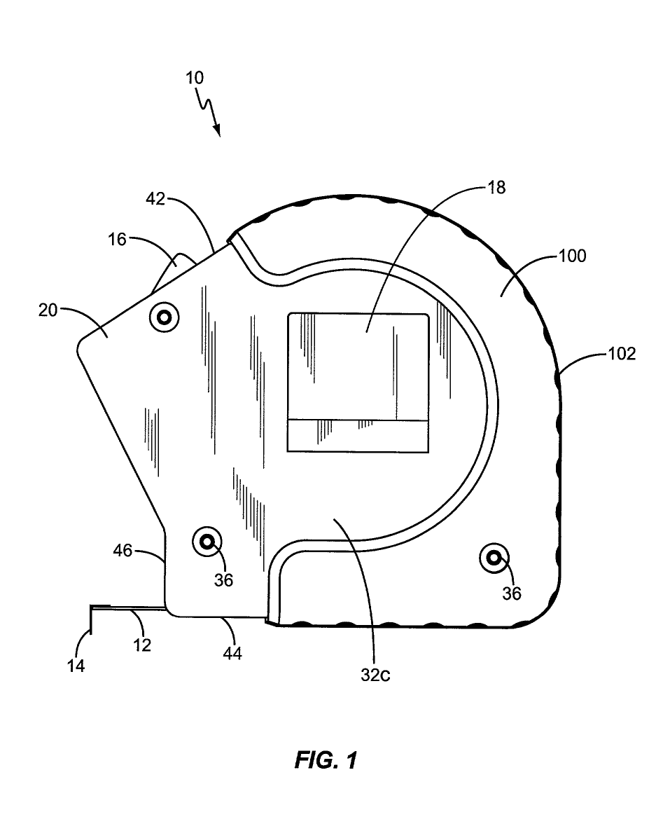

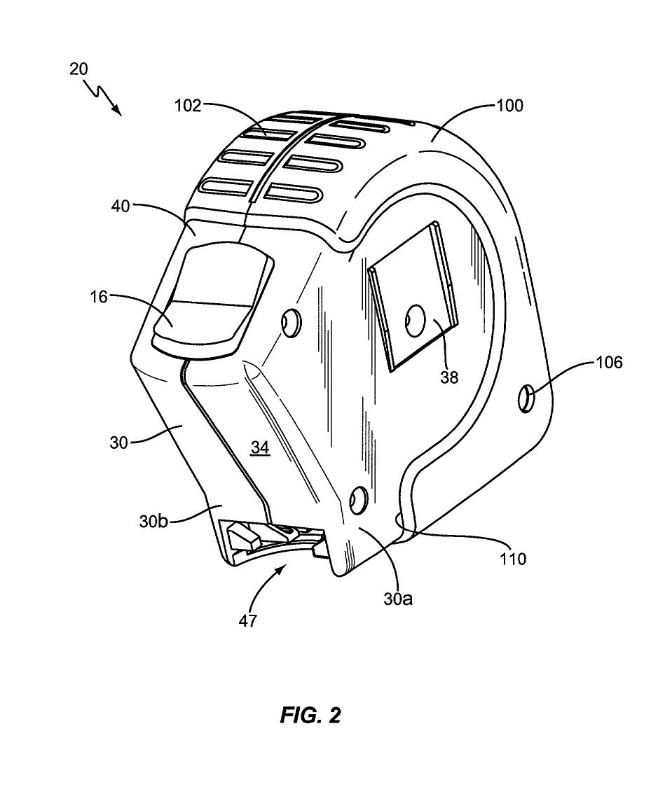

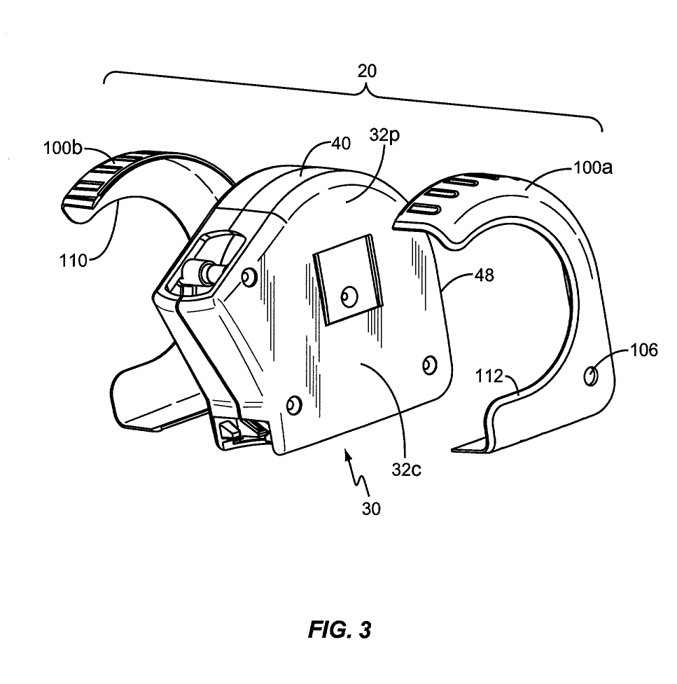

As illustrated in FIG. 1, a tape measure, generally designated 10, is shown constructed according to the present invention. The tape measure 10 includes a coilable measuring tape or blade 12 and an associated housing 20. The distal end of the tape 12 may include an end hook 14 to prevent it from being retracted into the housing 20. A tape-biasing device (not shown), such as a spring, is operatively connected to the tape 12 to bias it towards a retracted orientation. A locking mechanism, including a toggle 16 or similar actuator is provided to aid in controlling the movement of the tape 12 into and out of the housing 20. One or both sides of the housing 20 may include a clip 18, as desired. As the general design and operation of coilable tape measures are well known in the art, additional detailed discussion of the components other than the housing are omitted herein for brevity. However, additional discussion may be found in U.S. Pat. Nos. 4,527,334; 4,976,048; and 6,349,482 which are incorporated herein by reference.

The housing 20 generally includes a main case or shell 30 and a grip element 100 mounted on the shell 30. The housing 20 preferably has a generally squarish shape, with a rounded rear corner and may have a slightly projecting nose, as shown in FIG. 1. The housing 20 includes an opposing pair of sidewalls 32 and an interconnecting peripheral wall 40 that help define an internal chamber 50 that houses the coiled portion of the tape 12, a suitable tape-biasing device, and portions of the locking mechanism. As shown in the Figures, the peripheral wall 40, and thus the shell 30, may be thought of as having a top 42, a bottom 44, a front 46, and a rear 48. The housing 20 typically includes an opening 47 near its lower front corner that connects to the internal chamber 50. The distal end of the tape 12 extends through this opening 47. The housing 20 is preferably sized to fit within a user's hand, and also conveniently stored on a work belt or in a toolbox.

The shell 30 may be constructed from two portions, a right-hand portion 30a and a left-hand portion 30b, joined together by suitable screws 36, as is known in the art. The two portions 30a,30b may have different internal configurations, depending on the internal workings of the tape measure 10, also as is known in the art. However, as the present invention primarily relates to the external configuration of the housing 20, the details of the internal configuration of the shell 30 are not relevant to understanding the present invention, and the following discussion will focus on the external structure of the housing 20.

Each shell portion 30a,30b includes a generally flat external sidewall 32 and a peripheral flange 34 that extends generally perpendicular to the sidewall 32 and helps form the peripheral wall 40. A smooth radiused curve 33 joins the external surfaces of the sidewall 32 and flange 34. While the external surfaces of the shell 30 may have some recesses, such as recess 38 for mating with a belt clip 18, but there should not be a recess that runs from the peripheral wall 40 over onto the sidewalls 32, such as in the Wertheim device, as discussed further below. Shell 30 is preferably made from a durable material such as a hardened plastic (e.g., ABS, polycarbonate, or the like).

Overlaying the external portions of the flange 34 and at least a portion of the sidewall 32 is an elastomeric grip element 100. As shown in the Figures, the grip element 100 may advantageously subtend an arc of approximately 240°, extending from the upper portion of the peripheral wall 40 proximate the toggle 16, around the rear 48 of shell 30, and along the bottom 44 approximately ⅔ of the way to the opening 47. Of course, other amounts of coverage with respect to the shell 30 also fall within the scope of the invention, provided that the grip element 100 covers at least the crest or high point of the peripheral wall 40 and at least a portion of the rear 48. Just by way of example, the grip element 100 may subtend an arc of approximately 300°, extending from the upper portion of the peripheral wall 40 proximate the toggle 16, around to cover a lower portion of the front 46. The underside of the grip element 100 is generally smooth. The external surface of the grip element 100 may advantageously include a plurality of spaced indentions 102 and/or raised ridges to aid in gripping by the user. Like the shell 30, the grip element 100 may be formed from two portions, one portion 100a associated with the right-hand portion 30a of the shell 30 and one 100b associated with the left-hand portion 30b of the shell 30. The grip element 100 should be made from elastomeric materials that exhibit reasonable resistance to degradation by grease and dirt, such as polyurethanes, polyisoprenes, and polybutylenes, and may be advantageously comolded with the respective shell portion 30a,30b. A preferred material because of its ability to bond to an ABS shell 30 in an comolding operation (sometimes called “overmolding”) is an thermoplastic elastomer (TPE) sold by Network Polymers of Branford, Conn. under the trademark “Softflex 2701.” While the grip element 100 may be any desired thickness, a nominal thickness of approximately 0.065 inches may be advantageous. Further, one or both portions 100a,100b of the grip element 100 may include a hole 106 proximate the bottom-rear corner of the housing 20 for access to one of the screws 36 that help hold together the shell portions 30a,30b. The perimeter of this hole 106 may be tapered so as to allow for counter-sinking of the relevant screw 36.

The external configurations of both the shell portions 30a,30b and the grip element portions 100a,100b may advantageously be symmetrical if desired, but this is not required.

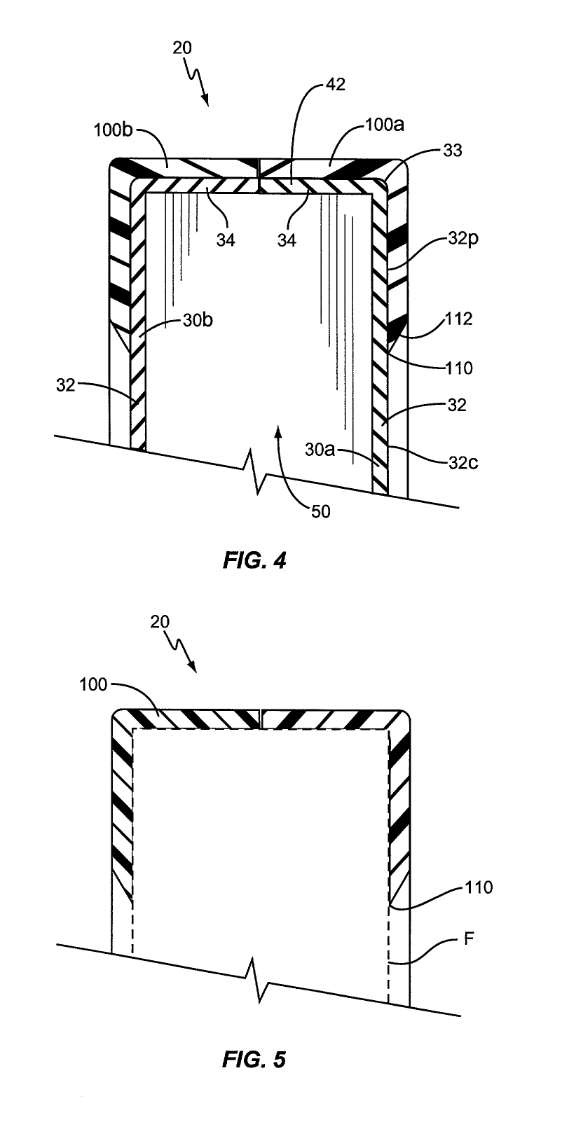

One characteristic of the tape measure housing 20 of the present invention is that the grip element 100 is not bounded by a recess wall (outward extending lip) on the shell 30. In other words, the main case 30 of such embodiments may be said to be “external recess-free” proximate the perimeter edge 110 of the grip element 100. As shown in the Figures, the boundary between the perimeter portion 32p of the sidewall 32 and the central portion 32c of the sidewall may be smoothly contiguous when viewed in cross-section, and may be advantageously generally planar (see FIG. 4). This boundary should be proximate the perimeter edge 110 of the grip element 100, so that the perimeter section 32p of the sidewall is covered, in the relevant locations, by the grip element 100 and the central section 32c of the sidewall 32 is left uncovered by the grip element 100. Thus, the external surface of the sidewalls 32 may be generally planar in cross-section, at least in the area proximate the perimeter edge 110 of the grip element 100 (i.e., straight or very gently curved from a point in the perimeter section 32p covered by the grip element 100 but near perimeter edge 110 to a point in the central section 32c not covered by the grip element 100 but also near perimeter edge 110). As can be seen in FIG. 4, this arrangement results in a grip element 110 having an open, C-shaped cross-section. Because the grip element 100 is not bounded by a recess wall, the grip element 100 may advantageously include a tapered section 112 leading to the perimeter edge 110, which typically takes the form of a chamfer (see FIG. 4). The chamfer may be straight or gently curve, and may end with a radius portion at the perimeter edge 110 or may taper to a point in cross-section. Locating the perimeter edge 110 of the grip element 100 outside of any recess, and instead overlaying the grip element 100 over the shell 30, helps eliminate the possible pinch-point between a recess wall and the grip element present in the Jones and Wertheim devices, thereby improving the feel of the tape measure 10 of the present invention.

An alternate way of viewing the relationship between the shell 30 and the grip element applicable to some embodiments of the case 20 is to note that the grip element 100 may be described as being disposed external to any recesses on the sidewalls 32. Thus, the portion of the grip element 100 proximate the perimeter edge 110 is not disposed within a recess (the volume of space bounded by the corresponding recess wall), but is instead external to any recess. Still another way of viewing the relationship between the shell 30 and the grip element 100 applicable to some embodiments of the case 20 is to note that the grip element 100 may be described as laying substantially outside the external footprint of the first and second sidewalls 32. The external footprint corresponds to a theoretical cross-sectional box formed by the linear extensions of the outermost portions of the top 42, the bottom 44, and the sidewalls 32 for the corresponding cross-section. An example of a footprint is shown in FIG. 5 and indicated at F.

It should be noted that one or both sidewalls 32 may optionally include an external recess (not shown), typically in the shape of a circle, for a suitable label. This recess should be spaced from the perimeter edge 110, so that there is a recess-free central section 32c of the sidewall 32 between the perimeter edge 110 and the label recess. Likewise, the clip recess 38 should be spaced from the perimeter edge 110, so that there is a recess-free central section 32c of the sidewall 32 between the perimeter edge 110 and the clip recess 38. With the added thickness of the housing 20 due to the grip element 100, it may be advantageous to shim or otherwise space the belt clip 18 out slightly from the relevant sidewall 32, so as to allow for the belt clip 18 to easily function as intended, such as by adding spacing ribs to the clip recess 38, the belt clip 18, or some added shim component disposed therebetween.

As the present invention relates to the external structure of the tape measure housing 20, particularly the interrelation of the shell 30 and the grip element 100, discussion of other details of the tape measure 10 not necessary for understanding the present invention have been omitted for clarity. However, it should be understood that the tape measures 10 of the present invention may also include other features such as shock-absorbing bumpers proximate the opening 47, specially coated blades 12, reinforcing hooks 14, various locking mechanisms, and like, all of which are known in the art.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

What is claimed is:

1. A tape measure housing, comprising:
a main case having first and second sidewalls and a peripheral wall extending between said sidewalls, said peripheral wall having a bottom portion, an top portion, a front end portion, and a rear end portion, said sidewalls and said peripheral wall providing an internal chamber therewithin, said peripheral wall having an opening communicating with said chamber for passage of a tape blade therethrough disposed proximate a junction between said front end portion and said bottom portion;
an elastomeric grip element having a perimeter edge, said grip element disposed over at least some of said top portion and at least some of said rear end portion of said case, said grip element further extending a limited distance across said sidewalls to cover a perimeter section thereof and leave a central portion uncovered by said grip element; and
wherein said case is external recess-free proximate said perimeter edge.

2. The tape measure housing of claim 1 wherein said grip element is further disposed over at least some of said bottom portion.

3. The tape measure housing of claim 1 wherein said top portion of said case proximate said perimeter edge of said grip element has a smooth contour.

4. The tape measure of claim 3 wherein said top portion of said case has a smooth outer contour in the portion thereof covered by said grip element.

5. The tape measure housing of claim 1 wherein said grip element tapers proximate said perimeter edge.

6. The tape measure housing of claim 5 wherein said grip element tapers proximate said perimeter edge with a chamfer.

7. The tape measure housing of claim 1 wherein said sidewalls and said perimeter wall of said main case are provided by a pair of mating housing elements.

8. The tape measure housing of claim 7 wherein said grip element comprises a pair of cooperating sections bonded to corresponding housing elements of said main case.

9. The tape measure housing of claim 8 wherein said grip element comprises a pair of cooperating sections comolded to said corresponding housing elements of said main case.

10. The tape measure housing of claim 1 wherein said grip element further comprises an aperture disposed proximate a junction between said rear end portion and said bottom portion, and further comprising a fastener accessible via said aperture.

11. The tape measure housing of claim 1 wherein said central portion and said perimeter section of said first sidewall are generally smoothly contiguous.

12. The tape measure housing of claim 1 wherein said grip element has an open, generally C-shaped cross-section.

13. The tape measure housing of claim 1 wherein:
said top portion of said case proximate said perimeter edge of said grip element has a smooth contour;
said grip element tapers proximate said perimeter edge;
said sidewalls and said perimeter wall of said main case are provided by a pair of mating housing elements;
said grip element comprises a pair of cooperating sections comolded to corresponding housing elements of said main case;
said central portion and said perimeter section of said first sidewall are generally smoothly contiguous; and
said central portion and said perimeter section of said second sidewall are generally smoothly contiguous.

14. A tape measure housing, comprising:
a main case having first and second sidewalls and a peripheral wall extending between said sidewalls, said peripheral wall having a bottom portion, an top portion, a front end portion, and a rear end portion, said sidewalls and said peripheral wall providing an internal chamber therewithin, said peripheral wall having an opening communicating with said chamber for passage of a tape blade therethrough disposed proximate a junction between said front end portion and said bottom portion;
an elastomeric grip element having a perimeter edge, said grip element disposed over at least some of said top portion and at least some of said rear end portion of said case, said grip element further extending a limited distance across said sidewalls to cover a perimeter section thereof and leave a central portion uncovered by said grip element; and
wherein said sidewalls are generally planar from proximate said perimeter edge in said perimeter section covered by said grip element to proximate said perimeter edge in said central portion not covered by said grip element.

15. The tape measure housing of claim 14 wherein said grip element is further disposed over at least some of said bottom portion.

16. The tape measure housing of claim 14 wherein said grip element tapers proximate said perimeter edge.

17. The tape measure housing of claim 14 wherein said sidewalls and said perimeter wall of said main case are provided by a pair of mating housing elements.

18. The tape measure housing of claim 17 wherein said grip element comprises a pair of cooperating sections bonded to corresponding housing elements of said main case.

19. The tape measure housing of claim 18 wherein said grip element comprises a pair of cooperating sections comolded to said corresponding housing elements of said main case.

20. The tape measure housing of claim 14 wherein said grip element has an open, generally C-shaped cross-section.

21. The tape measure housing of claim 14 wherein:
said grip element tapers proximate said perimeter edge;
said sidewalls and said perimeter wall of said main case are provided by a pair of mating housing elements; and
said grip element comprises a pair of cooperating sections comolded to corresponding housing elements of said main case.

22. A tape measure housing, comprising:
a main case having first and second sidewalls and a peripheral wall extending between said sidewalls, said peripheral wall having a bottom portion, an top portion, a front end portion, and a rear end portion, said sidewalls and said peripheral wall providing an internal chamber therewithin, said peripheral wall having an opening communicating with said chamber for passage of a tape blade therethrough disposed proximate a junction between said front end portion and said bottom portion;
an elastomeric grip element having a perimeter edge, said grip element disposed over at least some of said top portion and at least some of said rear end portion of said case, said grip element further covering at least a portion of said sidewalls to cover a perimeter section thereof and leave a central portion thereof uncovered; and
wherein said perimeter edge is disposed external to any recess on said sidewalls.

23. The tape measure housing of claim 22 wherein said grip element has an open, generally C-shaped cross-section.

24. The tape measure housing of claim 22 wherein:
said grip element tapers proximate said perimeter edge;
said sidewalls and said perimeter wall of said main case are provided by a pair of mating housing elements; and
said grip element comprises a pair of cooperating sections comolded to corresponding housing elements of said main case.

25. A tape measure housing, comprising:
a main case having first and second sidewalls and a peripheral wall extending between said sidewalls, said peripheral wall having a bottom portion, an top portion, a front end portion, and a rear end portion, said sidewalls and said peripheral wall providing an internal chamber therewithin, said peripheral wall having an opening communicating with said chamber for passage of a tape blade therethrough disposed proximate a junction between said front end portion and said bottom portion;
an elastomeric grip element having a perimeter edge, said grip element disposed over at least some of said top portion and at least some of said rear end portion of said case, said grip element further covering at least a portion of said sidewalls to cover a perimeter section thereof and leave a central section thereof uncovered; and
wherein said perimeter edge of said elastomeric grip element lies substantially outside an external footprint of said first and second sidewalls.

26. The tape measure housing of claim 25 wherein:
said grip element tapers proximate said perimeter edge;
said sidewalls and said perimeter wall of said main case are provided by a pair of mating housing elements; and
said grip element comprises a pair of cooperating sections comolded to corresponding housing elements of said main case.

27. A tape measure, comprising:
a coilable tape;
a housing generally surrounding said tape when said tape is retracted substantially into said housing, said housing comprising:
a main case having first and second sidewalls and a peripheral wall extending between said sidewalls, said peripheral wall having a bottom portion, an top portion, a front end portion, and a rear end portion, said sidewalls and said peripheral wall providing an internal chamber therewithin, said peripheral wall having an opening communicating with said chamber for passage of a tape blade therethrough disposed proximate a junction between said front end portion and said bottom portion;
an elastomeric grip element having a perimeter edge, said grip element disposed over at least some of said top portion and at least some of said rear end portion of said case, said grip element further extending a limited distance across said sidewalls to cover a perimeter section thereof and leave a central section uncovered by said grip element; and
wherein said sidewalls are generally planar from proximate said perimeter edge in said perimeter section covered by said grip element to proximate said perimeter edge in said central portion not covered by said grip element.
